(19) United States
(12) Patent Application Publication
(10) Pub. No.: US 2016/0069111 A1
(43) Pub. Date: Mar. 10, 2016

(54) PROTECTIVE INTERFACE FOR A TEMPORARY CLOSURE DEVICE OF A MOTOR VEHICLE

(71) Applicant: EXSTO THERMOPLASTICS, Romans Sur Isere (FR)

(72) Inventors: Bertrand LEON, Tullins (FR); Eloi MOYART, Loriol (FR); Olivier BOURGEOIS, Le Pin (FR)

(73) Assignee: EXSTO THERMOPLASTICS, Romans Sur Isere (FR)

(21) Appl. No.: 14/785,164

(22) PCT Filed: Apr. 16, 2014
(86) PCT No.: PCT/FR2014/050932

§ 371 Date: Oct. 16, 2015

(30) Foreign Application Priority Data
Apr. 16, 2013 (FR) 13/53431

(51) Int. Cl. E05C 21/00; B05B 13/02

(52) U.S. Cl. CPC E05C 21/005; B05B 13/0292

(57) ABSTRACT

An interface is intended to be fixed to a first rim edge of an opening element or of a fixed element of a motor vehicle body in order to protect a retaining portion of a device for temporarily closing the opening element on the fixed element provided in order to carry out the steps of painting the motor vehicle from contact with the rim edge. The interface has a portion in the general shape of a cage intended to house the temporary closing device. A kit including the interface and the temporary closing device is also described.

The present invention relates to an interface intended to be fastened on a sharp flange of an openable element or of a fixed element of a coachwork of a motor vehicle, in order to protect, from contact with this sharp flange, the retaining means of a device intended for temporarily closing the openable element over the fixed element, which device is set in place prior to carrying out the steps of painting the motor vehicle.

The manufacturing lines of motor vehicles include lines that are dedicated for painting the coachworks which are fitted with openable elements, and in particular doors. These openable elements are not yet equipped with their ultimate closure devices or locks, and therefore, it is necessary to provide temporary and removable closure devices which allow holding the openable elements in an intermediate closed position with respect to the coachwork during its transfer through the painting line.

In the past, there have been proposed temporary closure devices that are mounted at the place dedicated to the ultimate lock by means of fastening members, such as for example screws. These devices are constituted by metallic parts which have a lifespan at least equal to the time duration required for manufacturing the vehicles on which they are used. However, the metallic parts risk deteriorating the coachwork and/or the paint as they are mounted or dismounted, and they have to undergo various cleaning treatments on a regular basis, at a frequency depending on the rapidity of fooling at each passage through the painting lines. In addition, after this cleaning treatment, the temporary closure devices are subjected to a compliance recovery operation on a checking layout.

There is also known a device for temporarily closing an openable element over a fixed element of a coachwork of a motor vehicle, a housing being formed in the openable element or in the fixed element, which comprises a body which is fitted with means for anchoring on the fixed element or on the openable element and which includes a retaining means designed so as to hold the openable element in an intermediate closed position with respect to the fixed element, the retaining means being formed by an elastic tab which is capable of bending when subjected to the stress exerted by a first flange of the housing on a free end of the tab during the displacement of the openable element from a freely openable position toward the intermediate closed position.

Nonetheless, this temporary closure device has the drawback of including a tab serving as a means for retaining the openable element, which tab is subjected to high stresses and strains when closing and opening the openable element over the fixed element. Therefore, the force that is to overcome when closing or opening this openable element is considerable. The coachwork elements are generally formed and cut by deep-drawing; the areas that are not visible by the ultimate customer (the buyer of the vehicle) are generally roughly finished, the edges of the cuts remaining sharp; these are generally the areas which may be used by the temporary closure devices.

However, when the openable element comes into contact with the tab and forces the latter to withdraw, the frictions that take place may pull off the paint layer(s) that have been applied over the openable element or remove these paint layer(s) if the paint is not yet dry. This is called the touchings problem.

Furthermore, after that the openable element has been handled several times, plastic or metallic dusts, depending on the nature of the constitutive material of the temporary closure device, originating from the latter, and more specifically from the tab because of its abrasion which is caused by the aforementioned frictions, or from the coachwork, may deposit over the coachwork, and constitute permanent visual defects once covered with a paint layer. Indeed, when passing into the cabin or into the oven, these dusts are conveyed by the ventilation mixing air and deposited again by gravity randomly over the coachwork. This results in the generation of grains, which consist of foreign bodies below the paint layers that have been subsequently applied and which are detrimental to the aspect of the finished vehicle. This is the reason why this is called the grains problem.

It should be noted that this problem of grains is compounded if the openable element further comprises a reinforcement. Indeed, in this case, two pull-out problems occur, which problems consist in that the openable element and the reinforcement may abrade the tab of the temporary closure device thereby generating more plastic and metallic dusts.

In order to avoid this and to comply with the quality criteria as regards the coachwork paint, the manufacturers of motor vehicles have to remove these grains by local grinding and by applying a new layer of paint. These meticulous operations seriously complicate the coachwork painting process and increase the cost thereof.

This is the reason why manufacturers seek to suppress, at any price, this visual imperfection from the openable element as well as from the fixed element, as this imperfection causes a very high recycling rate of the bodyshells and consequently results in additional manufacturing costs of the motor vehicles.

The invention aims to provide a solution which allows overcoming the drawbacks that have been detailed above and which is particularly appropriate for avoiding the generation of grains during the painting operations of the coachwork of the motor vehicle, and this when using a temporary closure device, such as described above, which may be abraded by a sharp flange of the fixed element or of the openable element.

A first object of the invention relates to an interface which presents a body, said body includes first fastening means which allow the interface to be fastened on an openable element or on a fixed element of a motor vehicle so as to protect a temporary closure device intended to be fastened on the openable element or on the fixed element in contact with a first flange of the openable element or of the fixed element, said temporary closure device being of the type including at least one body fitted with a resiliently-deformable retaining means designed so as to hold the openable element in an intermediate closed position with respect to the fixed element, said body of the interface further comprising at least one first abutment member presenting a rigidity determined so that the stresses that are exerted by the first abutment member of the interface against the retaining means of the temporary closure device, during the displacement of the openable element from an open position toward the intermediate closed position or during the displacement of the openable element from the intermediate closed position toward an open position, force the retaining means of the temporary closure device to be deformed and to withdraw when the first abutment member of the interface is in contact with the retaining means of the temporary closure device, said interface is characterized in that:
it comprises a first wall presenting a first wall portion and a second wall portion, said first wall portion being prolonged by said second wall portion, said second wall portion constituting the first abutment member of the interface, said first fastening means being designed so as to fasten said first wall portion against a wall of the first flange of the fixed element or of the openable element, and
it presents a generally cage-shaped portion which comprises a plurality of walls, said first wall portion of the first wall forming one of the walls of said plurality of walls of the generally cage-shaped portion.

Of course, the first abutment member of the interface may comprise any element attached on the second wall portion of the first wall of the interface.

By fastening the interface according to the invention on the openable element or on the fixed element, the first flange of the openable element or of the fixed element, generally presenting a sharp aspect and which may therefore abrade the retaining means of the temporary closure device, does no longer come into contact with this retaining means. Thus, the temporary closure device is no longer abraded after that the openable element has been handled several times, thereby limiting its deterioration, and in particular, the problem of the aforementioned grains is thereby avoided.

The first wall portion of the first wall of the interface constitutes a surface for contact with a wall of the first flange of the openable element or of the fixed element.

In addition, the second wall portion of the first wall of the interface which therefore protrudes from the first flange of the openable element or of the fixed element not only allows:
avoiding the formation of grains, but also
avoiding the problem of touchings.

In other words, when this second wall portion of the first wall of the interface comes into contact with the retaining means of the temporary closure device when the openable element is closed over the fixed element, or when the openable element is opened, the retaining means of the temporary closure device is distant enough from the visible (by the ultimate customer) areas of the openable element so as to avoid any touching in these areas, even in the case where the openable element has a specific geometric which usually causes touchings.

The interface according to the invention is particularly appropriate if the openable element or the fixed element, on which the interface is fastened, comprises no reinforcements and if it is not planned to subsequently cover the area where the interface was positioned during the painting operations with a plastic-made part.

The interface according to the invention is also appropriate in the cases where:
the fixed element or the openable element is devoid of reinforcements but the area where the interface was positioned during the painting operations is subsequently covered with a plastic-made part
the fixed element or the openable element comprises a reinforcement and the area where the interface was positioned during the painting operations is or is not subsequently covered with a part.

The generally cage-shaped portion has the advantage of providing a good mechanical strength to the interface.

The generally cage-shaped portion may be designed so as to be capable of accommodating the temporary closure device during the painting operations.

Preferably, the first wall portion and the second wall portion of the first wall of the interface are coplanar.

In an advantageous embodiment of the invention, the second wall portion of the first wall of the interface which constitutes the first abutment member of the interface presents a free end with a rounded edge. This rounded edge ensures that the interface according to the invention does not deteriorate the retaining means of the temporary closure device, by abrasion, when it is in contact with this rounded edge during the displacement of the openable element either from a freely openable position toward the intermediate closed position, or from the intermediate closed position toward a freely openable position.

Advantageously, the interface further comprises at least one gripping means. This has the advantage of allowing setting the interface in place easily and also recovering it easily once the painting operations are complete.

The interface is made of a plastic material or a metallic material. It may be made in one single piece.

In the case where the interface is made of a metallic material, it would have the advantage of having a better mechanical strength in comparison with an interface made of a plastic material.

In the case of an interface made of a plastic material, the mechanical strength of the plastic material will have to be improved, for example by using, in preference, a material filled with glass. This will allow improving the resistance of the material of the interface. Of course, it is possible to consider other solutions for improving the mechanical strength of the plastic material of the interface, which solutions are within the reach of those skilled in the art.

Advantageously, the generally cage-shaped portion comprises at least:
said first wall;
a second wall which is opposite to the first wall;
an upper wall which connects the first wall to the second wall;
a first lateral wall which connects the first wall to the second wall;
a second lateral wall which is opposite to the first lateral wall and which connects the first wall to the second wall.

The first wall, the second wall, the upper wall, the first lateral wall and the second lateral wall delimit a housing intended to accommodate said temporary closure device.

Preferably, the gripping means is disposed on the upper wall of the generally cage-shaped portion. Thus, it is particularly accessible to the operator. The interface according to the invention may thus be easily fastened on the openable element or on the fixed element of the motor vehicle.

The generally cage-shaped portion may further be connected to at least two bottom plates which comprise the first fastening means, said first fastening means being designed so as to fasten the first wall portion of the first wall of the interface against a wall of the first flange of the fixed element or of the openable element. These first fastening means may comprise screwing means. Of course, it is possible to consider other fastening means, which means are within the reach of those skilled in the art.

According to one embodiment of the invention, the second wall of the interface comprises an area intended to cooperate with an abutment presented by the temporary closure device.

Thus, in this embodiment of the invention, this area of the second wall of the interface also allows avoiding touchings, but at locations of the openable element or of the fixed element which are different from the locations where touchings occur, thanks to the second portion of the first wall of the interface.

Furthermore, when the interface according to this embodiment of the invention is fastened on the openable element, this area of the second wall of the interface has also the advantage of avoiding deformation of the openable element, in particular when the latter is slammed either by the operator, or because of impacts that are created during the transfers of the vehicle through the manufacturing process of the motor vehicle.

According to one variant of this second embodiment of the interface, this area, which is intended to cooperate with an abutment presented by the temporary closure device, comprises a second abutment member protruding from said area.

An object of the present invention relates to a kit which comprises:
at least one interface such as described above,
at least one temporary closure device of the type including at least one body fitted with a resiliently-deformable retaining means designed so as to hold an openable element in an intermediate closed position with respect to a fixed element.

Preferably, the retaining means of the temporary closure device is formed by a resilient tab.

Advantageously, the retaining means is formed by an elastic tab capable of bending when subjected to a stress exerted on a free end of the tab. Advantageously, the portion of the free end of the tab forms a snap-fit hook. This portion of the free end of the tab may form a snap-fit hook over a length comprised between one-quarter and one-half the length of the tab.

The temporary closure device may further include the following other features:
It includes an abutment intended to cooperate with a second flange of the fixed element or of the openable element during the displacement of the openable element from the freely openable position toward the intermediate closed position.
Its body is prolonged in its area substantially corresponding to the base of the tab by a bottom plate suspended above a recessed area, the bottom plate and the tab being connected by means of an arch-shaped portion which ensures a flexible connection.
The arch-shaped portion is connected to the tab substantially at its middle and to the bottom plate substantially at its free end.
The tab and the bottom plate form an acute angle.
The tab, the bottom plate and the arch-shaped portion are integral with the body of the device.
The snap-fit hook is located at the extreme end of the tab.
The thickness of the snap-fit hook is smaller than 2 mm.
The tab includes, at its base, a recessed area.
The body includes, below its lower face, a plate extending on either side of the body and perpendicular to this body, the lower surface of the plate being fitted with a plurality of studs forming a space between the plate and the corresponding bearing surface of the fixed element or of the openable element.
The studs are distributed along the periphery of the lower surface of the plate.

Another object of the present invention relates to an assembly comprising a fixed element, and openable element, at least one interface such as described above and at least one temporary closure device such as described above.

In one embodiment of the assembly, the temporary closure device is of type including at least one body fitted with a resiliently-deformable retaining means designed so as to hold the openable element in an intermediate closed position with respect to the fixed element.

In one embodiment of the invention, the interface is fastened on the fixed element and the temporary closure device is fastened on the openable element.

In another embodiment of the invention, the interface is fastened on the openable element and the temporary closure device is fastened on the fixed element.

Other features and advantages of the invention will appear upon reading the description that follows with reference to the appended drawings, wherein:

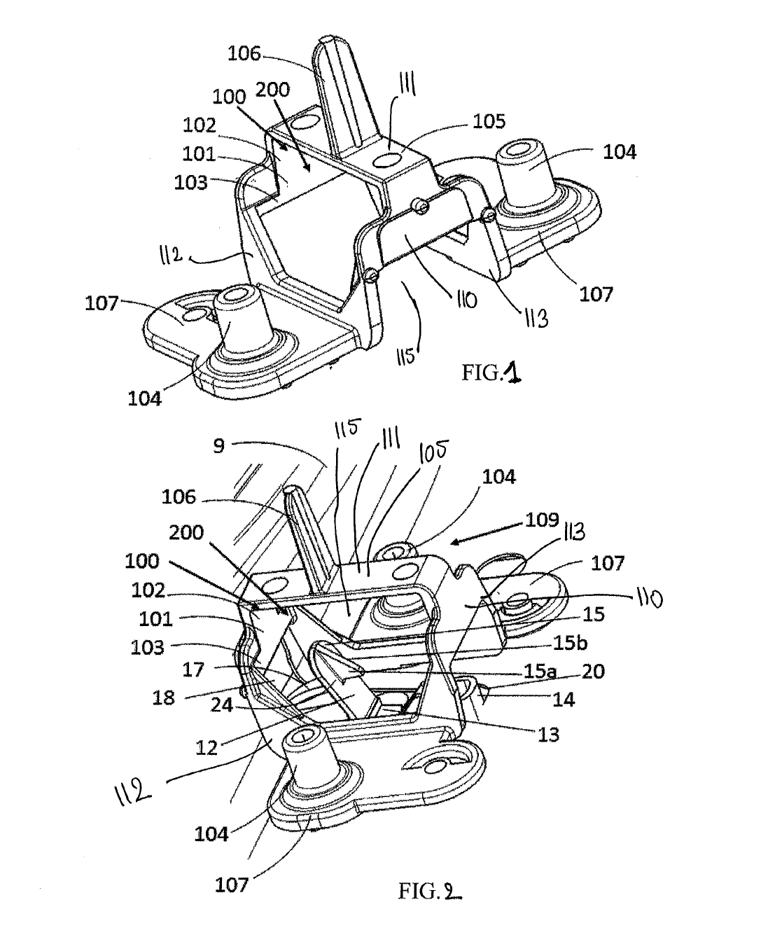

FIG. 1 is a perspective view of an interface according to a first embodiment of the invention.

FIG. 2 is a side perspective view of the interface represented in FIG. 1 which has been set in place on a first flange of an openable element, as well as a temporary closure device which is intended to be protected thereby.

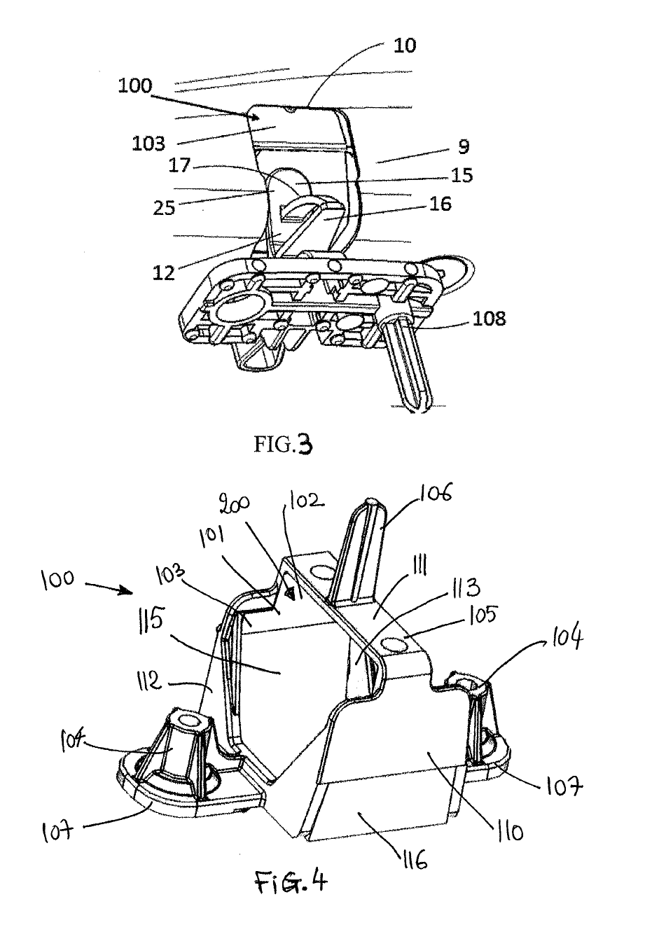

FIG. 3 is a rear perspective view of the interface, the openable element and the temporary closure device represented in FIG. 2.

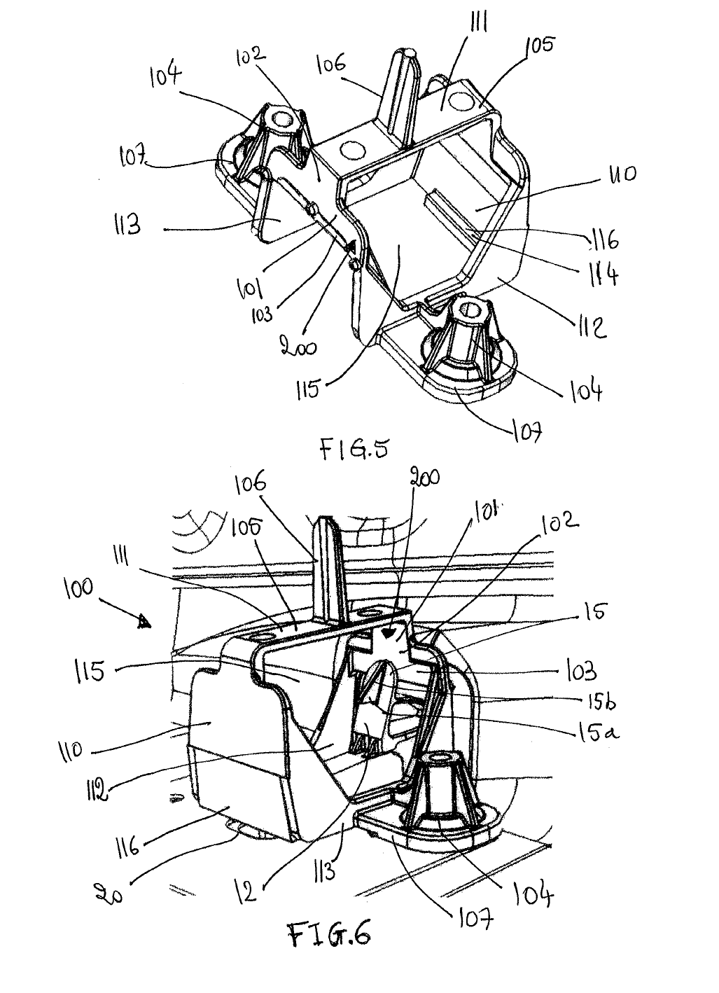

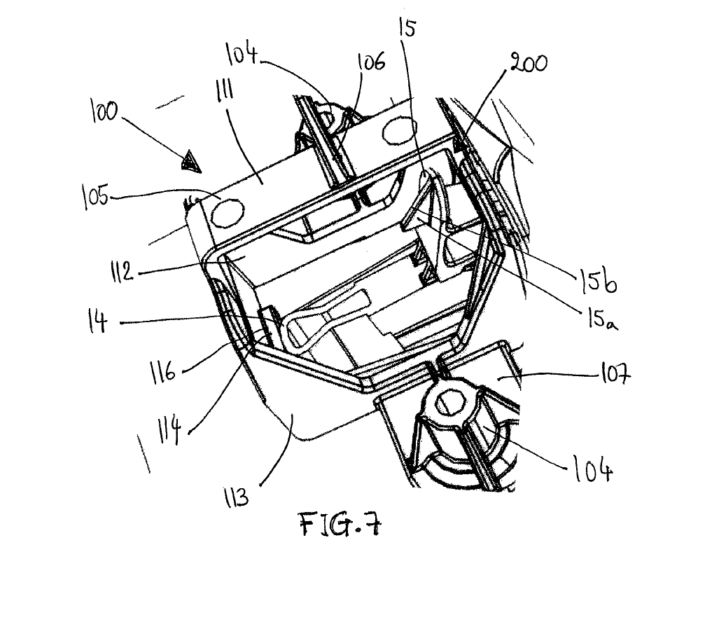

FIG. 4 is a perspective view of an interface according to a second embodiment of the invention.

FIG. 5 is a side perspective view of the interface represented in FIG. 4.

FIG. 6 is a perspective view of the interface represented in FIGS. 4 and 5 and which has been set in place on a first flange of an openable element, as well as a temporary closure device which is intended to be protected thereby.

FIG. 7 is another perspective view of the interface and the temporary closure device represented in FIG. 6.

FIG. 1 represents a first embodiment of an interface 100 according to the invention. The interface 100 comprises a body 200. The interface 100 presents a generally cage-shaped portion 105.

Said generally cage-shaped portion 105 comprises a plurality of walls.

The generally cage-shaped portion 105 comprises at least:
a first wall 101 which presents a first wall portion 102 and a second wall portion 103, said second wall portion 103 prolonging the first wall portion 102;
a second wall 110 which is opposite to the first wall 101;
an upper wall 111 which connects the first wall 101 to the second wall 110;
a first lateral wall 112 which connects the first wall 101 to the second wall 110;
a second lateral wall 113 which is opposite to the first lateral wall 112 and which connects the first wall 101 to the second wall 110.

The first wall 101, the second wall 110, the upper wall 111, the first lateral wall 112 and the second lateral wall 113 delimit a housing 115 intended to accommodate a temporary closure device 12 which is described hereinafter.

The second wall portion 103 of the first wall 101 constitutes a first abutment member of the interface 100.

Of course, the first abutment member of the interface 100 may comprise any element attached to the second wall portion 103 of the first wall 101 of the interface 100.

The first wall portion 102 and the second wall portion 103 are coplanar.

This generally cage-shaped portion 105, such as described above, has the advantage that the upper wall 111 and the first lateral wall 112 and the second lateral wall 113 contribute in enhancing the rigidity of the interface 100.

Thus, the interface 100 according to the invention presents a mechanical strength which is particularly appropriate for:
using the interface 100, properly, and this even in severe handling conditions, such as for example high temperatures, violent and sudden slams of an openable element 9,
using the interface 100 in situations where a significant force is required for retaining the openable element 9,

and this without the risk of losing the interface 100 through the manufacturing process of the motor vehicle, and particularly, during the steps of painting the coachwork.

The interface 100 further includes a gripping means 106 which is disposed on the upper wall 111. More specifically, the gripping means 106 extends along a direction substantially perpendicular to the upper wall 111. The gripping means 106 is generally in the form of a tab which is appropriate for manual handling.

The generally cage-shaped portion 105 is further connected to two bottom plates 107 each of which comprises first fastening means 104. These first fastening means 104 are designed so as to fasten the first wall portion 102 of the interface 100 against a wall of the first flange 10 of the openable element 9. These fastening means 104 consist of screwing means. Of course, in the context of the present invention, other first fastening means 104 may be considered, which means are within the reach of those skilled in the art.

The two bottom plates 107 are directed outward of the generally cage-shaped portion 105. They are substantially perpendicular to the first lateral wall 112 and to the second lateral wall 113 and they are disposed at an extreme end of said first lateral wall 112 and second lateral wall 113 opposite to the upper wall 111.

The interface 100 is fastened with the above-described first fastening means 104 on the openable element 9 in the proximity of holes (not visible in the figures) the openable element 9 is provided with.

These holes (not visible in the figures) consist of holes that are intended for fastening the ultimate locks of the motor vehicle. These holes are so-called [symbol] standard [symbol] since they are always located almost at the same locations on the openable elements 9 of motor vehicles, and this regardless of the manufacturer.

Thus, it is possible to easily use these holes, which are intended for fastening the ultimate lock, for fastening the interface 100 on the openable element 9 during the manufacturing operations of the motor vehicle, and in particular prior to the painting operations.

Since all openable elements 9 (namely the fore-left or the fore-right openable elements as well as the aft-left or aft-right openable elements) of a motor vehicle present such standard holes, the interface 100 according to the invention can be fastened, without any difficulty, on each one of the different openable elements 9 that a motor vehicle comprises.

Moreover, similarly to the openable element 9, the fixed element 18 of a motor vehicle also comprises standard holes intended for fastening the ultimate lock. Thus, the interface 100 according to the invention is also appropriate for being fastened with the standard holes of a fixed element 18 of a motor vehicle.

This has the advantage that it is possible to fasten the interface 100 according to the invention on the openable element 9 or on the fixed element 18 without the need for any modification of the openable element 9 or the fixed element 18 (in other words, without modifying the design of the openable element 9 or the fixed element 18).

Thus, the interface 100 according to the invention is particularly advantageous, and this in particular:
Since the same interface 100 according to the invention can be fastened on an openable element 9 as well as on a fixed element 18 of a motor vehicle by using the standard holes that are intended for fastening the ultimate lock. Such a standardization of the interface 100 according to the invention allows reducing its manufacturing cost. In other words, the interface 100 according to the invention is a multi-purpose standard part.
Fastening the interface 100 according to the invention on an openable element 9 or on a fixed element 18 does not require specific constraints or arrangements on these elements. The interface 100 is perfectly appropriate for all designs of openable elements 9 and fixed elements 18, and this for any type of motor vehicle. In other words, the interface 100 according to the invention is perfectly compatible with any type of motor vehicle, since it is fastened on standard holes that the openable elements 9 and the fixed elements of motor vehicles always include.

Referring to FIGS. 2 and 3, prior to passage in the coachwork painting line, the interface 100 has been fastened on a sharp first flange 10 of the openable element 9 and the temporary closure device 12 has been fastened on the fixed element 18.

FIG. 2 represents an assembly 109 which comprises an openable element 9, a fixed element 18, the interface 100 represented in FIG. 1, as well as a temporary closure device 12 which has been fastened on the fixed element 18.

In FIG. 3, there are also shown the means 108 for fastening the temporary closure device 12 on the fixed element 18.

In FIGS. 2 and 3, the temporary closure device 12 comprises a single-piece body 13 which includes an abutment 14 intended to cooperate with a second flange 20 of the openable element 9, during the closure of the openable element 9, as well as a retaining means in the form of a tab 15.

The tab 15 presents:
a front face 24 which comprises a flat snap-fit hook 15a including a tapered lead surface 15b.
a rear face 25.

The snap-fit hook 15a is perpendicular to the front face 24 of the tab 15.

The body 13 of the temporary closure device 12 is prolonged, in its area substantially corresponding to the base of the tab 15, by a bottom plate 16. This bottom plate 16 constitutes a secondary tab intended to take up part of the stresses and of the strain of the tab 15. For this purpose, the rear face 25 of the tab 15 and the bottom plate 16 are connected by means of an arch-shaped portion 17 which ensures a flexible connection. The arch-shaped portion 17 is connected to the tab 15 at its middle, and to the bottom plate 16 at its free end. Bending of the tab 15 is all the more limited as the stresses and the strain are distributed over different portions of the temporary closure device 12.

Referring to FIG. 2, the first flange 10 is initially located in front of the tab 15. Then, during the closure of the openable element 9, because of the determined rigidity of the interface 100, the second wall portion 103 of the first wall 101 of the interface 100 comes into contact with the tapered lead surface 15b of the tab 15 so as to force this tab 15 to be deformed by bending, and then, withdrawing so that the first flange 10 passes behind the tab 15. Once past the first flange 10, the interface 100 no longer exerts stresses on the tab 15, the tab 15 then recovers its initial position, thanks to its elasticity. Upon closure, the abutment 14 of the temporary closure device 12 cooperates with the second flange 20 of the openable element 9.

With an interface 100 such as represented in FIGS. 1 to 3, during the closure of the openable element 9, the first flange 10 does not come into contact with the tab 15, and in particular, with the tapered lead surface 15b of the tab 15. Therefore, the first flange 10 does not risk abrading the tab 15.

During opening, the second wall portion 103 of the first wall 101 of the interface 100 comes into contact with the rear face 25 of the tab 15 so that it forces this tab 15 to be deformed by bending, and then, withdrawing so that the first flange 10 passes again in front of the tab 15.

Thus, with this first embodiment of the interface 100, as the openable element 9 is opened and closed during the painting operations, the sharp first flange 10 never comes into contact with the tab 15. Indeed, it is the second wall portion 103 of the first wall 101 of the interface 100 which, during the displacements of the openable element 9, comes into contact with the tab 15 and, because of its rigidity, forces it to be resiliently-deformed.

Besides the aforementioned problems of grains, the interface 100 has also the advantage of overcoming the problems of touchings.

The problems of touchings may occur because of contact frictions between the tab 15 and the first flange 10 of the openable element 9. A visible consequence of this consists of peeling of the paint (or wiping of this paint in the event where this paint is not yet dry) in the proximity of the first flange 10.

Since the second wall portion 103 of the first wall 101 of the interface 100 protrudes from the first flange 10, as can be seen in FIG. 3, it is also possible that contact frictions occur between the second wall portion 103 of the first wall 101 of the interface 100 and the tab 15. Nonetheless, the paint that is likely to peel off because of these contact frictions will be localized on the interface 100 which is a part that is intended to be dismounted upon completion of the painting operations of the coachwork. In other words, whether the paint peels off the interface 100 or is removed from the interface 100, when it is not yet dry, does not constitute a problem, and the visible effects of the problems of touchings do not take place when such an interface 100 is set in place during the painting operations.

FIGS. 4 to 7 represent a second embodiment of the interface 100 according to the invention.

The interface 100 according to this second embodiment of the invention differs from the interface 100 according to the first embodiment in that the second wall 110 comprises an area 116 intended to cooperate with the abutment 14 of the temporary closure device 12. This area 116 serves as an abutment for the abutment 14 of the temporary closure device 12.

According to one variant of this second embodiment of the interface 100, which variant is illustrated in FIGS. 5 to 7, this area 116 comprises a second abutment member 114 protruding form said area 116.

According to this variant of the invention, this second abutment member 114 is intended to cooperate with the abutment 14 of the temporary closure device 12 upon closure of the openable element 9, as can be seen in particular in FIG. 7.

Thus, unlike the interface 100 according to the first embodiment of the invention, with the interface 100 according to the second embodiment of the invention, which interface comprises an area 116 intended to cooperate with the abutment 14 of the temporary closure device 12, upon closure of the openable element 9, the abutment 14 of the temporary closure device 12 no longer cooperates with the second flange 20 of the openable element 9 which may also be sharp like the first flange 10.

Similarly to the second wall portion 103 which constitutes the first abutment member of the interface 100, the area 116 of the second wall 110 of the interface also allows avoiding touchings.

Furthermore, the area 116 presented by the interface 100 according to this second embodiment of the invention has also the advantage of avoiding deformation of the openable element 9, in particular when the latter is slammed either by the operator, or because of impacts that are created during the transfers of the vehicle through the manufacturing process of the motor vehicle.

In other words, the interface 100 according to this second embodiment of the invention presents an additional member intended for protecting the temporary closure device 12 in contrast with the interface 100 according to the first embodiment of the invention.

Indeed, with the interface 100 according to the second embodiment, the temporary closure device 12 is protected not only from the sharp first flange 10 in the proximity of the tab 15, but also from the sharp second flange 20 of the openable element 9 in the proximity of its abutment 14.

Moreover, in this second embodiment of the interface 100, the first fastening means 104 are disposed between the two load areas which are:
on the one hand, the second wall portion 103 with the tab 15, and
on the other hand, the area 116 with the abutment 14 of the temporary closure device 12.

This has the advantage that the interface 100 according to this second embodiment of the invention better resists the mechanical stresses.

Of course, the present invention is not limited to the embodiments of the interface such as described above. It is evident that it encompasses all technically-feasible equivalents of the described means as well as their combinations if these are within the scope of the invention.

1. An interface which presents a said body includes first fastening means which allow the interface to be fastened on an openable element or on a fixed element of a motor vehicle so as to protect a temporary closure device intended to be fastened on the openable element or on the fixed element of the contact with a first flange of the openable element or of the fixed element said temporary closure device being of the type including at least one body fitted with a resiliently-deformable retaining means designed so as to hold the openable element in an intermediate closed position with respect to the fixed element said body of the interface further comprising at least one first abutment member presenting a rigidity determined so that the stresses that are exerted by the first abutment member of the interface against the retaining means of the temporary closure during the displacement of the openable element from an open position toward the intermediate closed position or during the displacement of the openable element from the intermediate closed position toward an open position, force the retaining means of the temporary closure device to be deformed and to withdraw when the first abutment member of the interface is in contact with the retaining means of the temporary closure device,
wherein:
said interface comprises a first wall presenting a first wall portion and a second wall portion, said first wall portion being prolonged by said second wall portion said second wall portion constituting the first abutment member of the interface, said first fastening means being designed so as to fasten said first wall portion against a wall of the first flange of the fixed element or of the openable element and
said interface presents a generally cage-like portion which comprises a plurality of walls, said first wall portion forming one of the walls of said plurality of walls of the generally cage-like portion.

2. The interface according to claim 1, wherein the first wall portion and the second wall portion of the first wall of the interface are coplanar.

3. The interface according to claim 1, wherein the second wall portion of the first wall of the interface presents a free end with a rounded edge.

4. The interface according to claim 1, wherein it further comprises at least one gripping means.

5. The interface according to claim 1, wherein it is made of a plastic material or of a metallic material.

6. The interface according to claim 1, wherein the generally cage-shaped portion comprises at least:
said first wall;
a second wall which is opposite to the first wall;
an upper wall which connects the first wall to the second wall;
a first lateral wall which connects the first wall to the second wall;
a second lateral which is opposite to the first lateral wall and which connects the first wall to the second wall.

7. The interface according to claim 6, wherein the first wall, the second wall, the upper wall, the first lateral wall and the second lateral wall delimit a housing intended to accommodate the temporary closure device.

8. The interface according to claim 6, wherein the second wall comprises an area intended to cooperate with an abutment presented by the temporary closure device.

9. A kit comprising:
at least one interface according to claim 1,
at least one temporary closure device of the type including at least one body fitted with a resiliently-deformable retaining means designed so as to hold an openable element in an intermediate closed position with respect to a fixed element.

10. An assembly comprising:
a fixed element,
an openable element,
at least one interface according to claim 1,
at least one temporary closure device of the type including at least one body fitted with a resiliently-deformable retaining means designed so as to hold the openable element in an intermediate closed position with respect to the fixed element.
